(19) United States
(12) Patent Application Publication
(10) Pub. No.: US 2008/0317381 A1
(43) Pub. Date: Dec. 25, 2008

(54) IMAGE PROCESSING APPARATUS, IMAGE PROCESSING METHOD, AND PROGRAM THEREFOR

(75) Inventor: Makoto Tomita, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/140,255

(22) Filed: Jun. 16, 2008

(30) Foreign Application Priority Data
Jun. 25, 2007 (JP) 2007-166690

(51) Int. Cl. G06K 9/36

(52) U.S. Cl. 382/276

(57) ABSTRACT

An image processing apparatus capable of reducing operator's waiting time and improving operating feeling and productivity. To carry out remote print, image is read. As a result of an operator's UI operation, if only part of the read image is required to continue image processing, the order of vectorization processing is changed as desired, and vectorization of pages having a possibility of being required to continue the image processing is precedingly implemented or is completed at completion of an operator's UI operation to finalize operation for instruction.

### BACKGROUND OF THE INVENTION

1. Field of the Invention

The present invention relates to an image processing apparatus and an image processing method for image copying or other processing, and a computer-readable program for causing an image processing apparatus to carry out the image processing method.

2. Description of the Related Art

Conventionally, there is known a technique for converting image information being input from image input equipment into data of a format independent of characteristics of particular output equipment and for outputting the converted data in accordance with the characteristics of the output equipment (see Japanese Laid-open Patent Publication No. 5-314251). Such technique contemplates obtaining the same copying result between plural pieces of output equipment having different output characteristics.

In the above described image communication apparatus, a sender facsimile apparatus converts image data of a raster format (bitmap format) into vectorized data (vectorization processing) and transmits the vectorized data to a receiver facsimile apparatus in which the vectorized data is converted into image data and then visibly output. To generate the vectorized data, two-dimensional coordinate values of ends of a dot line, for example, are determined and converted into vector coordinate values. With this technique, an output quality does not change depending on particular output equipment, resulting in an advantage of an increased degree of freedom of combination between input equipment and output equipment.

The above advantage is especially noted with regard to a copy function to be carried out between input equipment and output equipment placed away from each other, such as for example, a copy function in a remote copy system disclosed in Japanese Laid-open Patent Publication No. 11-331455 in which image input and image output are implemented by different equipment which are connected via a network (remote copy function).

In the case of an image being input from input equipment and temporally stored in the form of vectorized data in an image memory, an operator is able to perform format setting and give instructions for page editing, image processing, etc. It is also possible to generate a new job by combining the image with another job stored in advance or by cutting and pasting the image on a page-by-page basis, and instruct printing of the new job.

However, the above image vectorization processing requires relatively complex and numerous calculations, and takes a long time to complete. Furthermore, to vectorize raster image data of a plurality of pages, the vectorization processing must be performed in an order in which the raster image pages are read into the image memory, and therefore, any operations such as printing and data output for which the image must be used cannot be carried out before completion of the vectorization processing on all the pages. As a result, even if there is a job to be executed that includes only a part of the pages of the raster image data, subsequent processing must be started after completion of the vectorization processing on all the pages, resulting in a waste of time for the operator to wait for completion of printing including the vectorization processing. In other than the vectorization processing, the above problems can be caused in rasterizing processing on vectorized data of a plurality of pages, color space conversion processing on color image data of a plurality of pages, and the like.

### SUMMARY OF THE INVENTION

The present invention provides an image processing apparatus and an image processing method which are capable of reducing operator's waiting time and improving operation feeling and productivity, and provides a program therefor.

According to a first aspect of the present invention, there is provided an image processing apparatus comprising a data conversion unit adapted to generate converted data based on image data, a data transfer unit adapted to transfer the converted data generated by the data conversion unit to a unit for performing output processing on the converted data, a setting unit adapted to make setting for the output processing, and a processing order management unit adapted, in a case where the data conversion unit generates converted data of a plurality of pages based on image data of a plurality of pages, to change, based on contents of the setting made by the setting unit, an order of execution of converted data generation processing on the image data of at least one among the plurality of pages for which the converted data generation processing is to be carried out.

According to a second aspect of the present invention, there is provided an image processing method comprising the steps of (a) generating converted data based on image data, (b) transferring the converted data generated in the step (a) to a unit for outputting the converted data, (c) making setting for the output processing, and (d) changing based on contents of the setting in the step (c), in a case where converted data of a plurality of pages is generated in the step (a) based on image data of a plurality of pages, an order of execution of converted data generation processing on the image data of at least one among the plurality pages for which the converted data generation processing is to be carried out.

According to a third aspect of this invention, there is provided a computer-readable program for casing an image processing apparatus to carry out the above described image processing method.

According to the present invention, operator's waiting time at the time of printing, etc., can be reduced and a time period up to completion of printing can be shortened, making it possible to improve operation feeling and productivity.

Further features of the present invention will become apparent from the following description of an exemplary embodiment with reference to the attached drawings.

### BRIEF DESCRIPTION OF THE DRAWINGS

FIG. 1 is a block diagram showing the overall construction of an image processing system according to one embodiment of this invention;

FIG. 2 is a block diagram showing an exemplar construction of each of first and second multifunction peripherals shown in FIG. 1;

FIG. 3 is a block diagram showing an example of the module construction of controller software that operates on a control unit of the first multifunction peripheral shown in FIG. 1;

FIG. 4 is a flowchart showing an example of procedures of scan processing implemented by the control unit;

FIG. 5 is a flowchart showing another example of procedures of scan processing;

FIG. 6 is a flowchart showing an example of vectorization processing in the scan processing shown in each of FIGS. 4 and 5;

FIG. 7 is a view showing an example of a screen displayed on an operation unit of the first multifunction peripheral when remote print is instructed;

FIG. 8 is a view showing an example of a screen displayed on the operation unit for indication of a list of selectable documents;

FIG. 9 is a view showing an example of a job editing operation screen;

FIGS. 10A and 10B are a timing chart for explaining the execution order of scan processing and remote print processing;

FIG. 11 is a flowchart showing an example of vectorization processing for performing control shown in FIGS. 10A and 10B;

FIG. 12 is a flowchart showing an example of processing queue list update processing implemented in the vectorization processing in FIG. 11;

FIG. 13 is a flowchart showing an example of processing queue list interruption update processing implemented in the vectorization processing in FIG. 11; and

FIG. 14 is a view showing in detail how a processing queue list is used.

### DETAILED DESCRIPTION OF THE PREFERRED EMBODIMENT

The present invention will now be described in detail below with reference to the drawings showing a preferred embodiment thereof.

System Construction

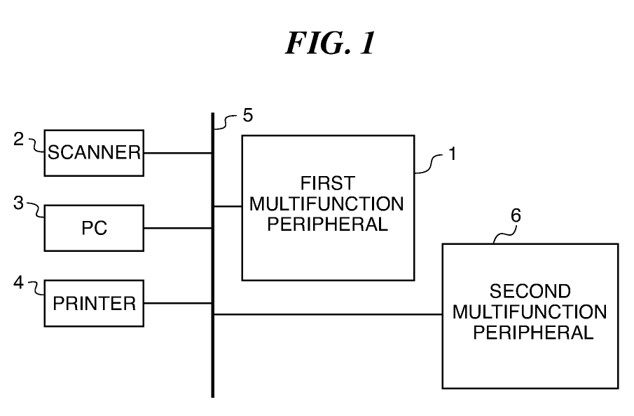

FIG. 1 shows in block diagram the overall construction of an image processing system according to one embodiment of this invention.

The image processing system of this embodiment in FIG. 1 includes, as a minimum construction, an image input apparatus, a data storage apparatus, and an image output apparatus. Each of first and second multifunction peripherals 1 and 6 meets the minimum construction requirement of the image processing system.

A scanner 2, a PC 3, and a printer 4 (respectively functioning as an image input apparatus, a data storage apparatus, and an image output apparatus) connected together via a LAN 5 also meet the minimum construction requirement of the image processing system.

Construction of Controller Unit

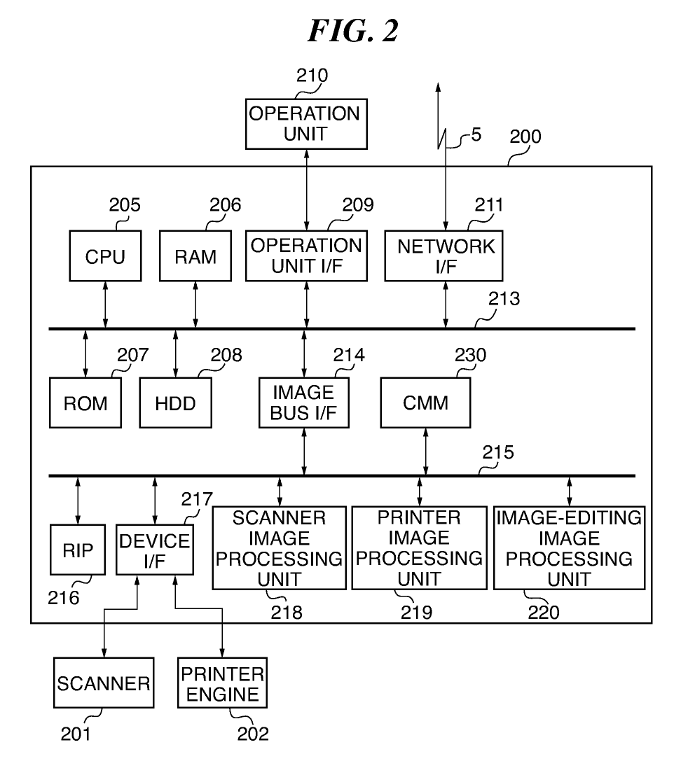

FIG. 2 shows in block diagram an example of the construction of each of the first and second multifunction peripherals 1 and 6 of the image processing system.

Referring to FIG. 2, each of the multifunction peripherals 1 and 6 includes a control unit 200, a scanner 201, a printer engine 202, and an operation unit 210. The control unit 200 is connected to the scanner 201 as an image input device and the printer engine 202 as an image output device, and controls reading and print output of image data. By being connected with the LAN 5, the control unit 200 controls input/output of image information and input/output of device information via a network.

In the control unit 200 in FIG. 2, a CPU 205 is a central processing unit for controlling the entire system, a RAM 206 is a system work memory for operation of the CPU 205 and an image memory for temporal storage of input image data. A ROM 207 is a boot ROM in which a boot program for the system is stored. An HDD 208 is a hard disk drive in which system software for various processing, input image data, etc. are stored.

In FIG. 2, an operation unit I/F 209 is an interface unit for the operation unit 210. The operation unit I/F 209 is an interface that outputs image data to the operation unit 210 having a display screen for displaying thereon image data, etc. The operation unit I/F 209 transmits information being input from the operation unit 210 by an operator (i.e., a user of the image processing system) to the CPU 205. A network interface 211, which is implemented for example by a LAN card, is connected to the LAN 5 for input and output of information from and to an external apparatus.

In this embodiment, the above described devices of the control unit 200 are connected to a system bus 213.

An image bus I/F 214 is an interface through which the system bus 213 is connected to an image bus 215 for transferring image data at a high speed. The image bus I/F 214 is a bus bridge for converting data structure. The image bus 215 is implemented for example by a PCI bus or IEEE 1394. Connected to the image bus 215 are a RIP 216, a device I/F 217, a scanner image processing unit 218, a printer image processing unit 219, an image-editing image processing unit 220, and a color management module (CMM) 230, which will be described below.

The raster image processor (RIP) 216 decompresses PDL codes and the below-mentioned vector data into raster (bitmap) data. The device I/F unit 217 connects the control unit 200 with the scanner 201 and the printer engine 202.

The scanner image processing unit 218 performs correction, modification, editing, etc. on input image data. The printer image processing unit 219 performs correction on printout image data in accordance with a printer characteristic and performs resolution conversion, etc. on print output image data. The image-editing image processing unit 220 carries out various processing such as rotation, compression, and decompression of image data. The CMM 230 is a special-purpose hardware module for performing color conversion processing on image data in accordance with profile and calibration data.

The scanner 2 is similar in construction to the multifunction peripherals 1 and 2 in FIG. 2 except that it does not include the printer engine 202 and the printer image processing unit 219. The printer 4 is similar in construction to each multifunction peripheral in FIG. 2 except that it does not include the scanner 201 and the scanner image processing unit 218.

Controller Software Construction

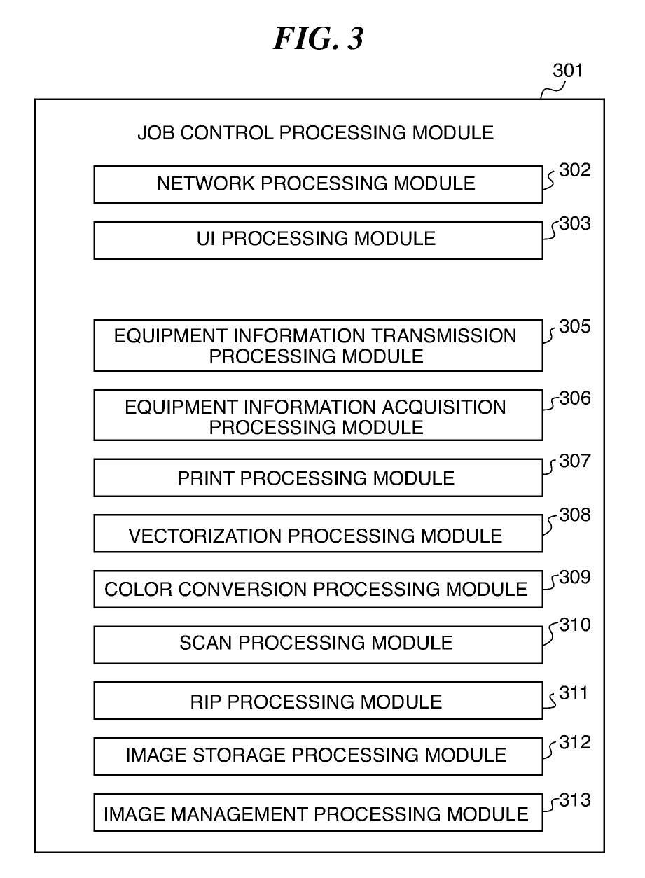

FIG. 3 shows in block diagram an example of the construction of a controller software module that operates on the control unit 200 of the multifunction peripheral 1 in FIG. 1. This controller software mainly operates on the CPU 205.

The job control processing module 301 in FIG. 3 performs the overall control of software modules shown in FIG. 3 and others not shown therein, and controls every job in the multifunction peripheral 1. A network processing module 302 mainly controls communication with the outside world through the network I/F 211, and controls communication with equipment connected to the LAN 5. When receiving control commands and data from the equipment connected to the LAN 5, the network processing module 302 notifies the received content to the job control processing module 301. In accordance with instructions from the job control processing module 301, the network processing module 302 transmits control commands and data to the equipment connected to the LAN 5.

A UI processing module 303 mainly controls the operation unit 210. Specifically, the UI processing module 303 notifies the job control processing module 301 of a content of operation performed by an operator at the operation unit 210, and in accordance with instructions from the job control processing module 301, controls a content displayed on the display screen of the operation unit 210. In accordance with instructions from the job control processing module 301, a print processing module 307 controls the image-editing image processing unit 220, the printer image processing unit 219, and the printer engine 202 to thereby perform print processing on a specified image.

From the job control processing module 301, the print processing module 307 accepts various information including image data, image information (image data size, color mode, and resolution), layout information (offset, zoom, and layout), and output sheet information (size and print direction). Then, the print processing module 307 controls the image processing unit 220 and the printer image processing unit 219 to perform proper image processing on image data, and controls the printer engine 202 to perform printing on a specified sheet.

In accordance with instructions from the job control processing module 301, a scan processing module 310 controls the scanner 201 and the scanner image processing unit 218 to read an original placed on the scanner 201. The instructions from the job control processing module 301 include a color mode in accordance with which processing is carried out by the scan processing module 310. Specifically, if the color mode is set to color, an original is input as a color image. If the color mode is set to monochrome, an original is input as a monochrome image. If the color mode is set to Auto, an original is subjected to dolor/monochrome determination by prescanning, and the original is input as color or monochrome image in accordance with a result of the determination.

The scan processing module 310 scans an original placed on a platen of the scanner 201 and inputs an image as digital data. Color information of the input image is notified to the job control processing module 301. The scan processing module 310 controls the scanner image processing unit 218 to perform appropriate image processing such as data compression on the input image, and notifies the job control processing module 301 of the image-processed input image.

In response to the notification of the image-processed input image from the job control processing module 301, an image storage processing module 312 stores the input image into the HDD 208. Upon receipt of notification of vectorized data from the job control processing module 301, the image storage processing module 312 stores the vectorized data into the HDD 208. Upon each completion of an image storage operation, the image storage processing module 312 gives, for each image, a notification to the job control processing module 301.

An image management processing module 313 manages images stored in the HDD 208 by the image storage processing module 312, and searches for and provides an image required by the job control processing module 301. Upon receipt from the job control processing module 301 a notification of an image for which the image storage processing has been completed, a vectorization (vectorized data generation) processing module 308 (data conversion unit) reads the notified image from the HDD 208 and performs vectorization processing thereon, whereby the read data is vectorized to be converted into data not dependent on resolution and output device. The thus generated data not dependent on resolution and output device is notified to the job control processing module 301.

In accordance with an instruction from the job control processing module 301, a color conversion processing module 309 performs color conversion processing on a specified image, and notifies the color-conversion-processed image to the job control processing module 301.

The job control processing module 301 notifies the color conversion processing module 309 of input color space information, output color space information, and an image to be subjected to color conversion. In accordance with an instruction from the job control processing module 301, an equipment information transmission processing module 305 transmits equipment information to specified equipment via the network processing module 302. The equipment information includes name of equipment, type of printer engine, resolution of printer engine, output profile, etc. In accordance with an instruction from the job control processing module 301, the equipment information acquisition processing module 306 transmits an equipment information acquisition request to a specified equipment via the network processing module 302.

In accordance with an instruction from the job control processing module 301, an RIP processing module 311 interprets PDL and vectorized data, and controls the RIP 216 to perform rendering for decompression into bitmap image.

The scanner 2 is similar in software construction to the module shown in FIG. 3 except that it does not include the print processing module 307 and the RIP processing module 311. The printer 4 is similar in software construction to the module shown in FIG. 3 except that it does not include the vectorization processing module 308 and the scan processing module 310.

Procedures of Scan Processing

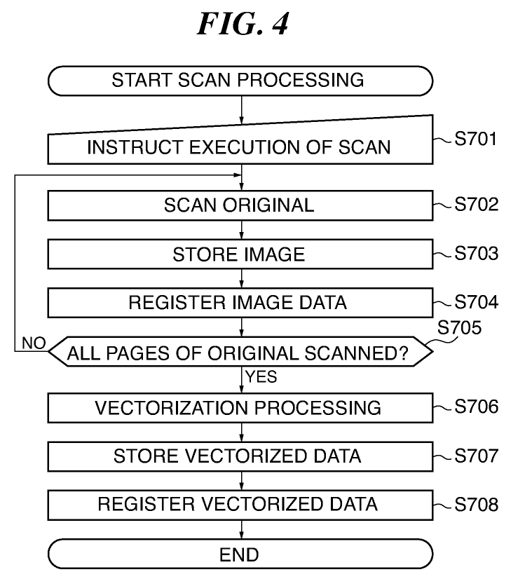

With reference to a flowchart of FIG. 4, the procedures for execution of scan processing is first described. FIG. 4 shows in flowchart an example of the procedures of the scan processing in this embodiment. The scan processing is implemented by the CPU 205 by reading and executing a program stored in the HDD 208, for example.

The scan processing is started when an operator sets an original of one or more pages onto the scanner 201 of the multifunction peripheral 1 and gives a job storage instruction from the operation unit 210 (step S701). When the operator performs various settings at the operation unit 210 and presses a start button (not shown), the UI processing module 303 notifies the job control processing module 301 of setting information and a scan image storage instruction. Upon receipt of the notification, the job control processing module 301 starts execution of scan image storage processing in step S702 and subsequent steps.

In step S702, the job control processing module 301 instructs the scan processing module 310 to scan the original set on the scanner 201 on a page-by-page basis and fetch the same as input image. The input image and color information notified from the scan processing module 310 are stored into a buffer on the RAM 206, whereupon the flow proceeds to step S703.

In step S703, the job control processing module 301 instructs the image storage processing module 312 to store the input image and the color information into the HDD 208. At this point of time, the input image data is raster data. Upon completion of the storage, the job control processing module 301 sends a registration notification to the image management processing module 313. The image management processing module 313 registers the input image as an available image into an available list (step S704). From that time point, the image management processing module 313 handles the input image stored in the HDD 208 as available data.

In step S705, whether or not all the pages of the original have been scanned is determined. The scanning operation is repeated, if there is an unscanned page of the original.

In step S706, the job control processing module 301 instructs the vectorization processing module 308 to implement vectorization processing. The vectorization processing is performed on the input image stored in the HDD 208. Upon completion of the vectorization, the job control processing module 301 instructs, in step S707, the image storage processing module 312 to store the vectorized data into the HDD 208. After the data is stored, the job control processing module 301 instructs the image management processing module 313 to register the vectorized data as available data in the available list in association with the input image (step S708). From that time, the image management processing module 313 handles the vectorized data stored in the HDD 208 as available data, as with the case of the input image.

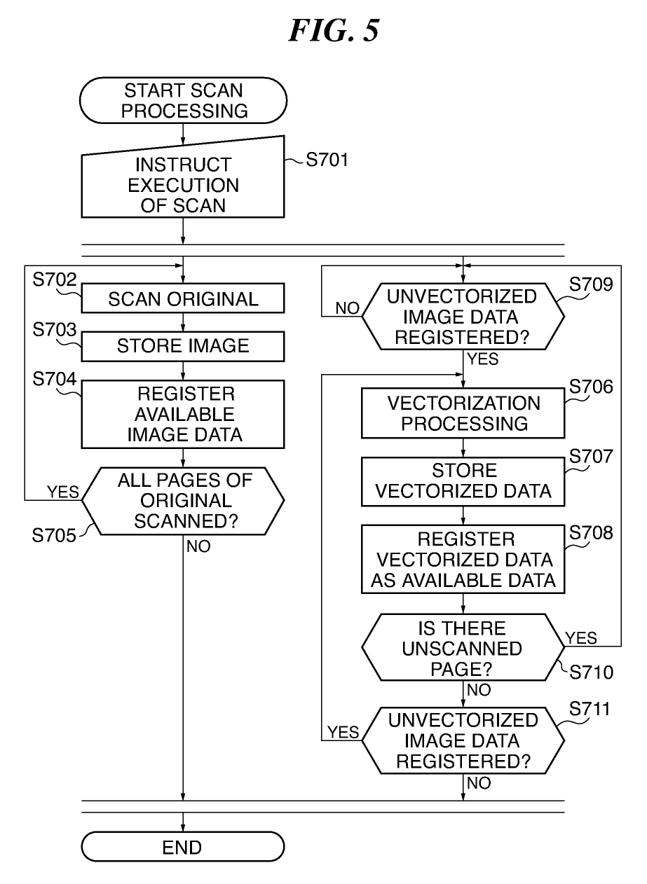

For simplification of explanation, the above example is described such that the flow does not proceed to step S706 until the image data of all the pages of an original is registered. However, the processing at steps S702 to S705 is usually carried out concurrently with the processing at steps S706 to S708. In the following, a description will be given of an arrangement in which such type of scan processing is implemented. FIG. 5 shows in flowchart the procedures of such scan processing.

As shown in FIG. 5, a series of vectorization processing at steps S706 to S708 is carried out concurrently with and independently of a series of original scan processing at steps S702 to S704. The steps S706 to S708 are repeated until the scanning of the original and all the vectorization processing are completed (steps S710 and S711).

The job information stored in the HDD 208 and containing image data and/or vectorized data can be utilized for output processing such as remote print and local print. The remote print refers to a form of output in which job information scanned and stored in advance is specified by an operator from an operation unit of some equipment connected via a network and printed by equipment different from the equipment in which the job information is stored. The local print refers to a case where equipment in which job information for remote print is stored, an operation unit for being operated by an operator, and output equipment are the same as one another.

Procedures of Vectorization Processing

The vectorization processing can be realized by performing either one of plural pieces of processing such as the below-mentioned OCR processing and outlining processing. Vectorized data can be obtained by performing either one of the above described processing. In the vectorized data, a plurality of image elements constituting a straight or curved line of an image are defined by mathematical expression. In this embodiment, it is assumed that the vectorization processing includes not only the OCR processing and the outlining processing but also processing for obtaining coded data or font data by means of character recognition or mark recognition. Raster image having regions at least part of which is vectorized also constitutes vectorized data. In this embodiment, algorithm for the vectorization processing is not limited.

Resolution conversion processing must be carried out, if the above described remote print is performed, or if the scanner of the multifunction peripheral 1 is different in resolution from the printer of the multifunction peripheral 6, or if image data to be transferred is raster image data. The image quality of raster image is usually deteriorated after the resolution conversion, whereas vector data is advantageous in that the image quality is not deteriorated or less deteriorated since conversion of vector data can be achieved simply by making conversion of coordinate values in mathematic expression representing a line, without resolution conversion being made.

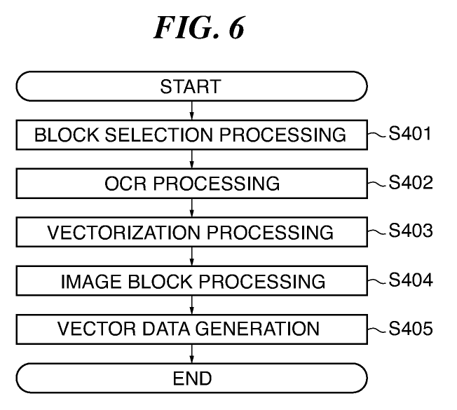

FIG. 6 shows in flowchart an example of the vectorization processing (step S706 in FIGS. 4 and 5). This processing is implemented by the CPU 205 by reading and executing a program stored in the HDD 208, for example.

In step S401, block selection processing is carried out on an image for which vectorization processing is to be made. In the block selection processing, objects contained in the image are divided into blocks, and an attribute of each block such as character (TEXT), image (PHOTO), line (LINE), graph (PICTURE), table (TABLE), or the like is determined.

In steps S402 to S405, vectorization processing is performed on the blocks divided in step S401. Specifically, OCR (character recognition) processing is carried out for a block determined as being characters (step S402). Then, the size, style, typeface, etc. of characters in the OCR processed character block are recognized, and the characters in the image are vectorized to convert them into visually faithful font data (step S403). A line block, a graph block, and a table block are vectorized by being outlined. On the other hand, an image block is image-processed for conversion into image data such as for example a JPEG file (step S404).

In step S405, the attribute and position information on each block determined in step S401 and the OCR information, font information, vector information and image information extracted in steps S402 to S404 are collected up as vectorized data.

Procedures of Remote Print

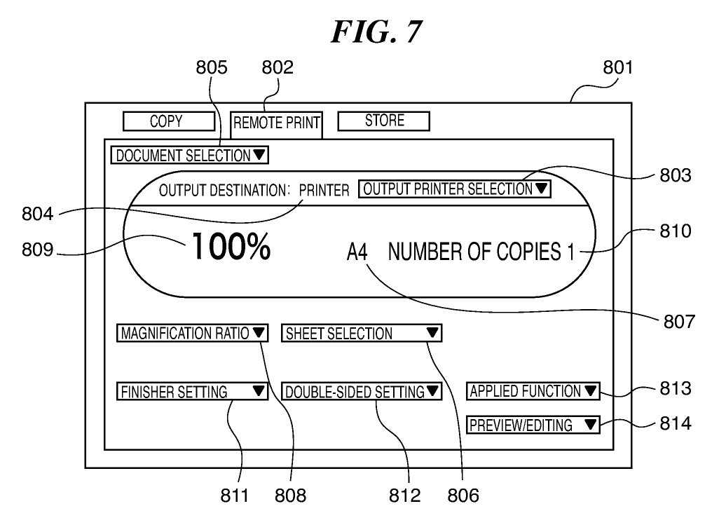

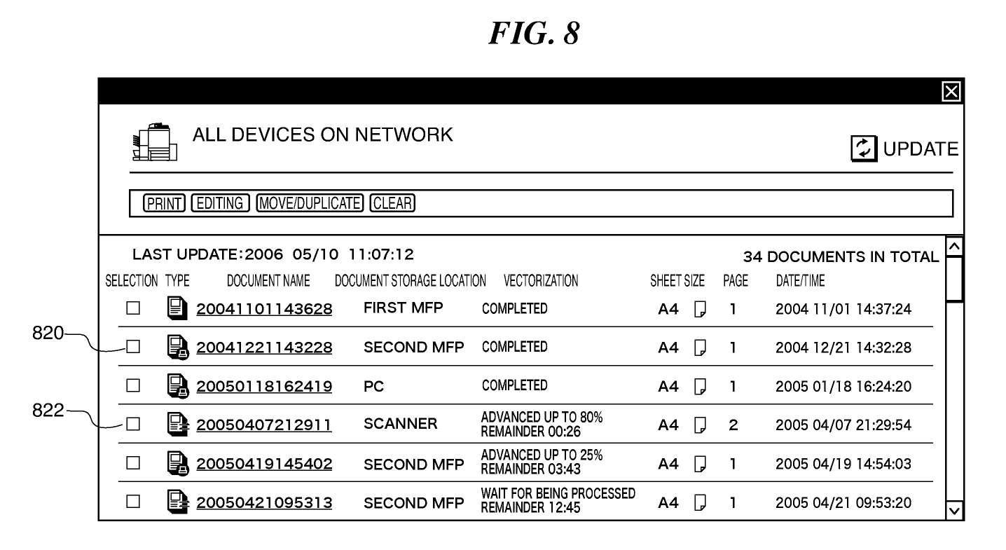

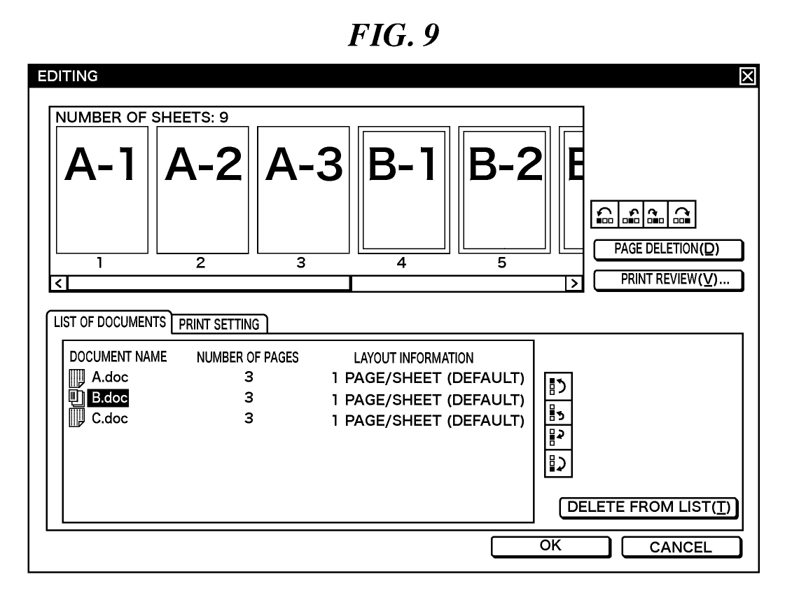

With reference to FIGS. 7 to 9, a remote print setting method according to this embodiment will be explained. FIG. 7 shows an example of a screen displayed on the operation unit 210 of the multifunction peripheral 1 when a remote print instruction is given, FIG. 8 shows an example of a screen on which a list of selectable documents is indicated, and FIG. 9 shows an example of a screen displayed for a job editing operation.

For explanation, equipment in which image data is retained and which is operated by an operator to give a remote print instruction will be referred to as the local equipment, and equipment for output will be referred to as the remote equipment. In a case for example that image data scanned by the first multifunction peripheral 1 in FIG. 1 is transmitted to and printed out by the second multifunction peripheral 6 or the printer 4, the first multifunction peripheral 1 corresponds to the local equipment and the second multifunction peripheral 6 or the printer 4 corresponds to the remote equipment. For the convenience of explanation, a description will be given of a case where equipment in which image data is retained is the same as equipment for being operated to give an instruction. Specifically, image data is retained by the multifunction peripheral 1, and the operator carries out a print operation at the operation unit 210 of the multifunction peripheral 1 and a print output is obtained by the printer 4.

In practice, a device for image data storage, equipment for instruction operation, and equipment for print may be different from one another. For example, there may be an arrangement where image data is retained in the multifunction peripheral 6, a print operation is performed by an operator at the operation unit of the multifunction peripheral 1, and a print output is obtained by the printer 4. Alternatively, a local print arrangement can be adopted in which all the functions including the function of the output equipment are achieved by the same device.

Remote print setting is made by the operator by operating the operation unit 210 of the first multifunction peripheral 1. A screen 801 shown in FIG. 7 is an example of a screen displayed on the display of the operation unit 210 for use by the operator to input a remote print instruction.

The screen 801 in FIG. 7 is for setting and starting the remote print and is displayed when a remote print mode button 802 is pressed by the operator. When the operator depresses a button 803, a list (not shown) of pieces of remote equipment that can be specified as remote print destinations is displayed to enable the operator to select a desired remote equipment therefrom. The remote equipment selected by the operator, e.g., the printer, is displayed as a setting result on a display area 804. The above described list of remote equipment which can be specified as destinations for remote print is dynamically acquired by making inquiry to a configuration management server, not shown, via the network. Alternatively, there may be an arrangement in which one or more output apparatuses replying to packets broadcasted to the network to search for one or more remote print acceptable output apparatuses are dynamically listed as remote equipment for being specified.

A button 805 is for selecting a document to be printout. When the operator depresses the button 805, a list of documents that can be selected for being printed out is displayed (FIG. 8), thereby permitting the operator to select one or more documents therefrom. The one or more selectable documents include one or more input images and vectorized data stored in the HDD 208 of the equipment, and/or one or more input images and vectorized data retained in other remote print acceptable equipment connected via the network.

The one or more input images and the vectorized data retained in other equipment may dynamically be obtained by making inquiry to a document management server, not shown, via the network. Alternatively, there may be an arrangement which dynamically lists vectorized data information retained in one or more output apparatuses replying to packets broadcasted to the network to search for one or more remote print acceptable output apparatuses.

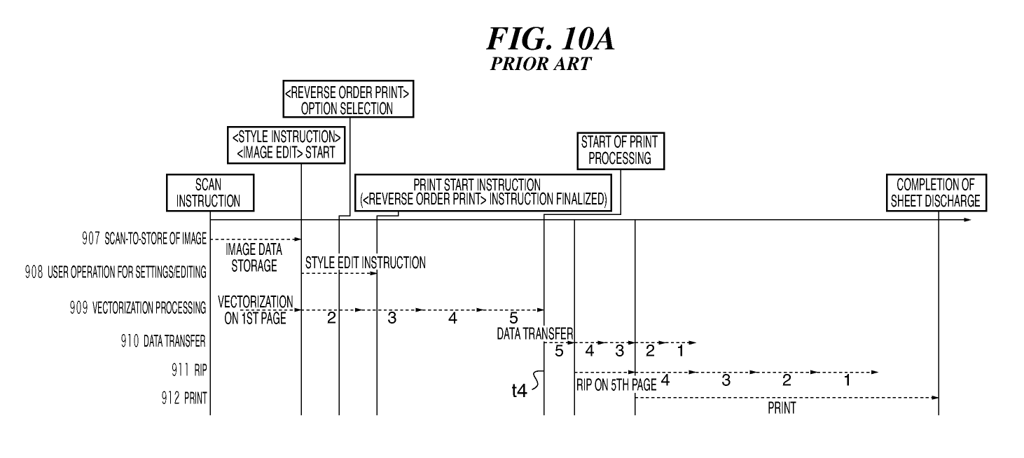

FIG. 8 shows an example of a list of documents displayed on the operation unit 210. On the list shown in FIG. 8, there are indicated names of equipment retaining data and the status of advance of vectorization processing as well as job information such as document names and the number of pages. Documents are indicated in the list upon completion of registration of available image data in the scan processing (step S704 in FIG. 4). Instructions for selection, editing, and printing can be given even on documents for which the vectorization processing has not been completed. For example, vectorization of a document shown by reference numeral 820 in the list is completed. This indicates that such document is vectorized data for which vectorization processing 903 in FIG. 10B or availability registration processing in step S708 in FIG. 5 has been completed. On the other hand, it is indicated that for an image shown at 822 in the list, raster data from the scanner has been stored but vectorization of the raster data has not been completed. In this embodiment, even the image data whose vectorization has not been completed is indicated in the document list to permit a job execution request thereon to be accepted.

Referring to FIG. 7 again, a button 806 is for selecting a sheet to be used for printout. When the operator depresses the button 806, a list of sheet sizes selectable for printout is displayed for selection of a desired sheet size therefrom. A sheet size to be used for printout is displayed in a display area 807. In the example of FIG. 7, the “A4” size is selected.

A button 808 is for specifying a magnification/reduction ratio at which an original image is to be remote printed. When the “magnification ratio” button 808 is depressed, a magnification ratio designation screen (not shown) is displayed to enable the operator to specify a magnification/reduction ratio thereon. The magnification/reduction ratio specified by the operator is displayed on a display area 809. In a display area 810, the number of copies to be remote printed is displayed. The number of copies can be set by the operator by operating a hard key, not shown.

A button 811 is used for finisher setting. When the button 811 is depressed, a finisher setting screen (not shown) is displayed for the setting of sort, staple, puncher, etc. A button 812 is used for double-sided designation. When the button 812 is depressed, a double-sided setting screen (not shown) is displayed on which a double-sided/single-sided setting, a binding-direction setting in the case of double-sided setting being selected, and the like can be made. A button 813 is used for an applied function setting. By depressing the button 813, a further advanced applied function such as “duplex-to-duplex copy”, “book-binding”, or “reduction layout” can be set.

A button 814 is used for previewing and editing an output result. When the button 814 is depressed, a job editing screen (FIG. 9) is displayed on which editing such as alteration or deletion of output order and blank page insertion can be instructed on a page-by-page basis. There can be adopted an arrangement in which image processing such as adjusting brightness and sharpness can be instructed on a page-by-page basis. In the job editing screen (FIG. 9), a preview of an output result is displayed based on vectorized data or based on an input image in respect of pages for which vectorization processing has not been completed, whereby setting/editing operation other than printing can be made even if the vectorization processing has not been completed.

When the operator makes various settings on the screen shown in FIG. 7 and depresses the start button among hard keys (not shown), the UI processing module 303 that operates on the control unit 200 of the multifunction peripheral 1 notifies the job control processing module 301 of the contents of settings and notifies the module 301 that remote print based on the settings has been instructed. The job control processing module 301 accepts, as a setting request, the contents of settings finalized at the UI processing module 303, and accepts a request for execution of remote print with the requested contents of settings. Then, the job control processing module 301 implements remote print processing.

Processing Order Management

With reference to FIGS. 10A and 10B, the order of execution of the scan processing and the remote print processing in this embodiment will be explained, compared to that in the prior art technique. In this example, a case will be described in which an original of five pages is read from the first page in order and printing is carried out in an output order which is reverse of the reading order.

FIGS. 10A and 10B are a timing chart for explaining the order of execution of the scan processing and the remote print processing.

When various settings are made from the operation unit 210 and then a scanned image storage instruction is given by the operator, scan-to-store processing 901 is implemented to scan input image and store the scanned image into the HDD 208. From completion of the processing on the first page, vectorization processing 903 is started in order and executed concurrently with scan processing.

When the scan-to-store processing 901 is completed up to the fifth page, the operator is able to carry out an various setting/editing operation 902 and start remote print setting. The operator specifies the order of output of pages to be in reverse order (at timing of t1), and depresses the start button, which is a hard key, not shown (at timing of t2).

At the time point of t1, the vectorization processing for the first page has been completed, whereas the vectorization processing for the second page is in execution. The CPU 205 of the control unit 200 recognizes at the timing t1 that vectorized data of the fifth page will initially be required for the print processing and vectorized data of the fourth, third, second, and first pages will then be required in this order. Even if the selection is not finalized, the order of execution of the vectorization processing is changed at the time point t1 where an operation for selecting the reverse order option is made in the various setting/editing operation 902. As a result, the vectorization processing is implemented in the expected required order. In the example in FIG. 10B, upon completion of vectorization of the second page which is in execution at the timing t1, the order of execution of vectorization is changed such that vectorization will be performed in the order of the fifth, fourth, and third pages.

In accordance with the printing order specified by the user, the data for which vectorization has been completed are transferred in the required order, as shown at 904, to the remote output equipment. In the example in FIG. 10B, the transfer to the remote equipment can be started at a time point of t3 where vectorization for the fifth page has been completed.

On the other hand, in the prior art, the order of execution of vectorization processing remains the same as the image input order. As a result, transfer of vectorized data cannot be started until completion of vectorization processing on all the required pages (timing t4 in the case of FIG. 10A).

In the remote equipment, RIP processing 905 is started in order and carried out concurrently with the data transfer processing 904 from when one-page transfer is completed. Upon completion of the one-page RIP processing, print processing 906 is implemented in order until completion of output of all the pages.

As shown in FIG. 10A, vector data transfer 910 is started at timing t4 in the prior art. On the other hand, in the embodiment, the vector data transfer 904 can be started at earlier timing t3, making it possible to improve the productivity of a job such as remote print.

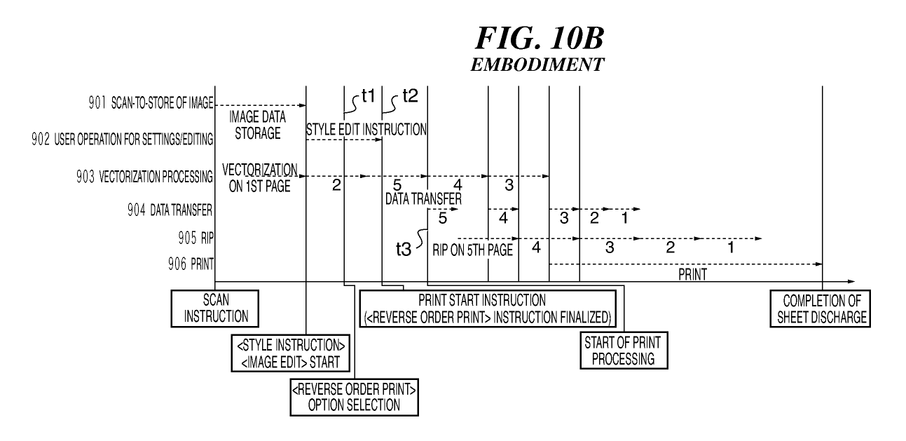

FIGS. 11 to 13 show in flowchart an example of the vectorization processing in the control in FIG. 10B, and examples of processing queue list update processing and processing queue list interruption update processing in the vectorization processing. These processing are implemented by the CPU 205 by reading and executing a program stored in the HDD 208, for example.

The vectorization processing is implemented in order in accordance with a processing queue list for the vectorization processing. The processing queue list is a data stream of a cue structure in which identifiers for page identification are recited. An example of use of the processing queue list will be described later. When a UI operation is performed (YES to S1001), the processing queue list is updated (S1002). The processing queue list update processing will be described later.

When a UI operation is not performed (N0 to S1001), vectorization processing is implemented on data at the head of the cue (S1003). Upon completion of the vectorization processing on that page, the page is deleted from the processing queue list (S1004). If there is an unprocessed page in the processing queue list (YES to S1005), the vectorization processing is repeated. If there is no unprocessed data in the list, the vectorization processing in FIG. 11 is completed.

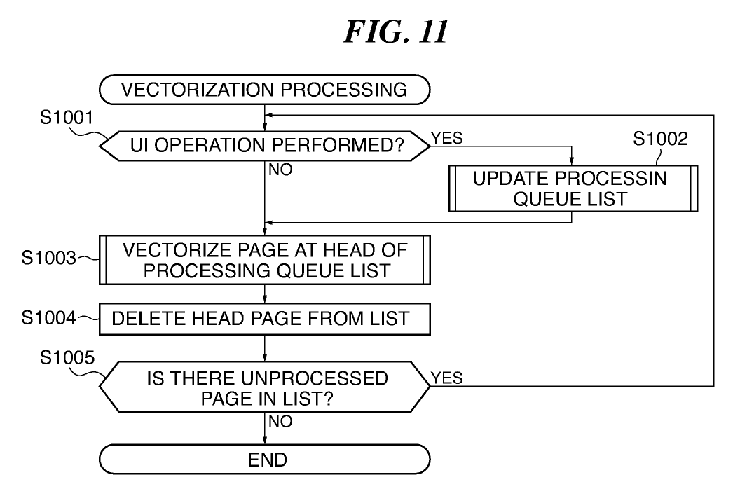

FIG. 12 shows in flowchart an example of the procedures of the processing queue list update processing carried out in the vectorization processing in FIG. 11.

On the basis of values set at the operation unit 210 at execution of the vectorization processing in FIG. 11, pages to be processed and the processing order of the pages are determined on an assumption that the settings are finalized (S1101). That is, even if the setting operation is not finalized, pages to be processed and the processing order of the pages are determined assuming that the settings are finalized.

The pages to be processed and the processing order of the pages are changed, for example, in the following cases where:

The order of jobs is changed;

Output equipment is changed, causing a change in the necessity/unnecessity of each pieces of vectorized data;

The order of pages is edited;

Addition or deletion is made on the pages;

A printing style is specified, causing a change in layout; or

A print range is specified and as a result the required pages are limited.

For example, it is assumed that pages of a first job which is three pages in total are represented as A, B, and C and pages of a second job which is four pages in total are represented by D, E, F, and G, respectively, and the first and second jobs are processed in this order. If vectorization processing on any page is not started, the processing queue list is represented as [ABCDEFG]. If the order of execution of jobs is changed to an order of the second and first jobs, the processing queue list is represented as [DEFGABC]. In a case that an output destination device for the first job does not require vectorized data, the processing queue list is represented as [DEFG]. If an additional page [H] is inserted at the end of the first job, the processing queue list is represented as [ABCHDEFG]. If the second page of the first job is deleted, the processing queue list is represented as [ACDEFG].

In a case that a printing style is specified and a saddle-stitching book-binding printing is then specified, the first page must be printed on one half of a front side of a beginning sheet, another half of the front side of the beginning sheet must be made to be blank, the second and seventh pages must be printed on a rear side of the beginning sheet, the third and sixth pages must be printed on a front side of the next sheet, and the fourth and fifth pages must be printed on a rear side of that sheet. In this case, the processing queue list is represented as [ABGCFDE]. When a print range from the second page to the third page is specified, the processing queue list is represented as [BC].

Referring to FIG. 12 again, after the order of processing on pages is determined, it is confirmed based on unfinalized UI setting values at the present time whether or not vectorization processing is completed on all the page data required to continue the execution of printing (S1102). If there is unvectorized page data, one or more identifiers representing a corresponding one or more pages are moved in required order to the head of the processing queue list (S1103).

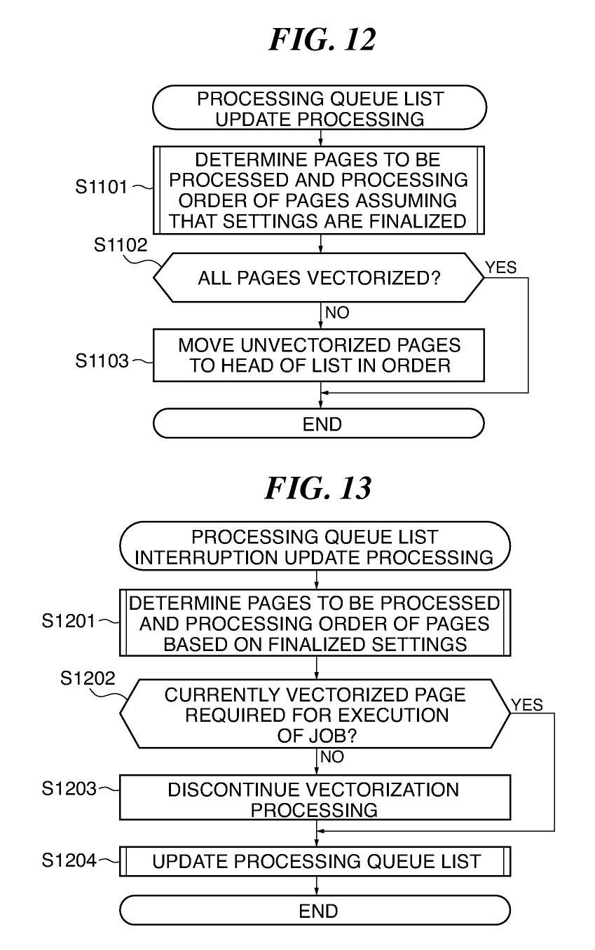

FIG. 13 shows in flowchart an example of the procedures of processing queue list interruption update processing implemented when settings are finalized at the operation unit 210.

When the settings at the operation unit 210 are finalized, the processing queue list interruption update processing in FIG. 13 is implemented in S1002 in FIG. 11, instead of executing the processing queue list update processing in FIG. 12.

First, in accordance with the settings finalized at the operation unit 210, pages to be processed are identified and the processing order of the pages is determined (S1201). Then, it is determined whether or not a page currently subjected to vectorization processing will be used in a job for which the operation is finalized (S1202). If it is determined that the page will be used in the job, the processing queue list is updated (S1204). Even if the processing queue list is updated, the page currently subjected to the vectorization processing is at the head of the processing queue list and the vectorization processing is continued to be performed.

If it is determined that the page currently subjected to the vectorization processing (vectorized data generation) will not be used in the job for which the operation is finalized, the vectorization processing is discontinued (S1203). In that case, in the processing queue list update processing (S1204), the processing order including the discontinued vectorization processing is calculated. When the processing queue list interruption update processing is completed, the vectorization processing is started again in S1003.

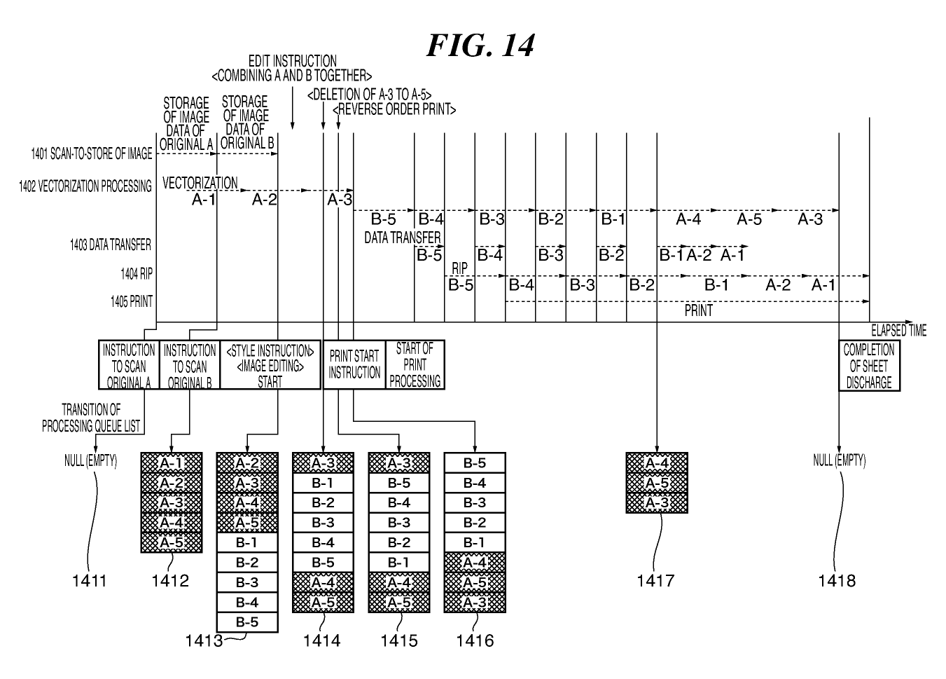

FIG. 14 describes the details of how to use the processing queue list and illustrates a timing chart and states of the processing queue list at various timings.

In this example, a case will be described in which an original A of five pages and an original B of five pages are read, the originals A and B are combined together, the third, fourth, and fifth pages of the original A are removed from the print range, and the entire output order is specified to be in reverse order to perform printing.

The processing queue list at an initial state is empty, as shown at 1411. When the various settings are made at the operation unit 210 and a scanned image storage instruction is given by the operator, the scan-to-store processing 1401 is implemented in the order of the original A and the original B to scan the input image and store the scanned image into the HDD 208. The scan-processed pages are added to the processing queue list in the scanning order. At completion of the scan processing on the original A, five pages of the original A are retained in the processing queue list, as shown at 1412.

From completion of the storing processing on the first page, vectorization processing 1402 is started in order and implemented concurrently with the scan processing. Pages for which the vectorization processing 1402 has been completed are deleted in order from the processing queue list. At completion of the scan processing on the original B, the vectorization processing on the first page of the original A is completed. As a result, pages other than the first page of the original A are retained in the processing queue list as shown at 1413.

At completion of the scan-to-store processing 1401 up to the fifth page of the original B, the operator is able to make various settings and editing, and remote print setting can be started.

First, the operator performs an operation of combining the originals A and B together. In a case if the combining operation is finalized, all the pages are required to implement processing and the printing order is the same as the scanning order. Thus, the processing queue list is the same as the one shown at 1413 and is not updated.

When the operator performs an operation of removing the third to fifth pages of the original A from the print range and if this setting is finalized, the third to fifth pages of the original A are no longer necessary for the processing. Thus, pages waiting for being processed, other than the third page of the original A currently being processed, are moved to the head of the processing queue list at the front of the fourth and fifth pages of the original A, which are no longer necessary. As a result, the processing queue list becomes as shown at 1414.

In a case where an operation is performed such that the whole originals will be printed in reverse order and if the resultant setting is finalized, the required order of processing the originals is represented as follows: The fifth, fourth, third, second, and first pages of the original B and the second and first pages of the original A should be processed in the mentioned order. To meet this requirement, pages waiting for being processed, other than the third page of the original A currently being processed, are changed in required order such as to be moved at the front of the fourth and fifth pages of the original A which are no longer necessary. As a result, the processing queue list becomes as shown at 1415.

When the start button, which is a hard key (not shown), is depressed by the operator to start print processing, the vectorization processing is temporarily discontinued and the processing queue list is updated since the third page of the original A currently subjected to the vectorization processing is unnecessary for the current job. As a result, the required pages are moved at the front of the third to fifth pages of the original A which are no longer necessary, and hence the processing queue list becomes as shown at 1416. Then, the execution of vectorization processing 1402 is restarted on the fifth page of the original B which is at the head of the processing queue list.

At the start of the print processing, data for which vectorization has been completed are transferred in the required order, as shown at 1403, to the remote output equipment. From completion of one-page transfer, RIP processing 1404 is started in order and implemented concurrently with data transfer processing 1403. Then, from completion of one-page RIP, print processing 1405 is carried out in order until completion of output of all the pages.

The print processing 1405 and the vectorization processing 1402 are implemented concurrently. When the vectorization processing on the required pages is completed, the processing queue list becomes as shown at 1417. The vectorization processing is also implemented on the remaining pages in the order specified by the processing queue list. When the processing on all the pages is completed, the processing queue list becomes empty again, as shown at 1418.

### ADVANTAGES ATTAINED BY THE PRESENT EMBODIMENT

With the present embodiment, the order of vectorization processing can be changed, as required, in accordance with an operator's UI operation. When the operator completes the UI operation to finalize the operation for instruction, pages having a possibility of being required can precedingly be vectorized or the vectorization of such pages can be completed. As a result, operator's waiting time can be reduced, and operation feelings and the productivity of the entire system can be improved.

In the embodiment, the processing for vectorizing raster images has been described. However, processing other than the vectorization processing may be carried out. For example, this embodiment is applicable to processing to rasterize input vectorized data (rasterize processing) or convert the color space of input image data (color space conversion processing). That is, this invention can be applied to the execution of a job that accompanies conversion processing in which any of the aforementioned processing is implemented on first image data to convert it into second image data.

It is to be understood that the present invention may also be accomplished by supplying a system or an apparatus with a storage medium in which a program code of software, which realizes the functions of the above described embodiment is stored and by causing a computer (or CPU or MPU) of the system or apparatus to read out and execute the program code stored in the storage medium.

In that case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, and a magnetic-optical disk, an optical disk such as a CD-ROM, a CD-R, a CD-RW, a DVD-ROM, a DVD-RAM, a DVD-RW, a DVD+RW, a magnetic tape, a nonvolatile memory card, and a ROM. The program code may be downloaded via a network.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2007-166690, filed Jun. 25, 2007, which is hereby incorporated by reference herein in its entirety.

What is claimed is:

1. An image processing apparatus comprising:
a data conversion unit adapted to generate converted data based on image data;
a data transfer unit adapted to transfer the converted data generated by said data conversion unit to a unit for performing output processing on the converted data;
a setting unit adapted to make setting for the output processing; and
a processing order management unit adapted, in a case where said data conversion unit generates converted data of a plurality of pages based on image data of a plurality of pages, to change, based on contents of the setting made by said setting unit, an order of execution of converted data generation processing on the image data of at least one among the plurality of pages for which the converted data generation processing is to be carried out.

2. The image processing apparatus according to claim 1, wherein said setting unit is able to accept a request for setting from outside, and
said processing order management unit changes, based on unfinalized contents of setting accepted by said setting unit in a state that the setting made by said setting unit is not finalized, the order of execution of the converted data generation processing on the at least one among the plurality of pages for which the converted data generation processing is to be carried out.

3. The image processing apparatus according to claim 2, wherein said processing order management unit changes, in a case where the order of execution of the converted data generation processing on the at least one among the plurality of pages for which the converted data generation processing is to be carried out is to be changed, an order of execution of the converted data generation processing on at least one among the plurality of pages for which the converted data has not been generated by said data conversion unit.

4. The image processing apparatus according to claim 2, wherein in a case where the setting made by said setting unit is finalized and the converted data is being generated based on the image data of at least one among the plurality of pages other than at least one page that will be required when the output processing is implemented in accordance with the finalized setting, said processing order management unit discontinues generation of the image data of the at least one among the plurality of pages, changes the order of execution of the converted data generation processing in accordance with an order of the at least one page that will be required when the output processing is implemented, and restarts the converted data generation processing based on the image data of the at least one among the plurality of pages the generation of which is discontinued.

5. The image processing apparatus according to claim 1, wherein said data conversion unit generates vectorized data based on raster image data,
said data transfer unit transfers the vectorized converted data generated by said data conversion unit to a unit for performing output processing on the vectorized converted data, and
in a case where said data conversion unit generates vectorized data of a plurality of pages based on raster image data of a plurality of pages, said processing order management unit changes, based on contents of the setting made by said setting unit, an order of execution of vectorized data generation processing on the raster image data of at least one among the plurality of pages for which the vectorized data generation processing is to be carried out.

6. An image processing method comprising the steps of:
(a) generating converted data based on image data;
(b) transferring the converted data generated in said step (a) to a unit for outputting the converted data;
(c) making setting for the output processing; and
(d) changing based on contents of the setting in said step (c), in a case where converted data of a plurality of pages is generated in said step (a) based on image data of a plurality of pages, an order of execution of converted data generation processing on the image data of at least one among the plurality of pages for which the converted data generation processing is to be carried out.

7. A computer-readable program for causing an image processing apparatus to carry out an image processing method, said image processing method comprising the steps of:
(a) generating converted data based on image data;
(b) transferring the converted data generated in said step (a) to a unit for outputting the converted data;
(c) making setting for the output processing; and
(d) changing based on contents of the setting in said step (c), in a case where converted data of a plurality of pages is generated in said step (a) based on image data of a plurality of pages, an order of execution of converted data generation processing on the image data of at least one among the plurality of pages for which the converted data generation processing is to be carried out.
